(19) United States
(12) Patent Application Publication
(10) Pub. No.: US 2005/0166178 A1
(43) Pub. Date: Jul. 28, 2005

(54) Process for global software development

(76) Inventors: Stephen P. Masticola, Kingston, NJ (US); Daniel J. Paulish, Yardley, PA (US)

Correspondence Address: Siemens Corporation;Intellectual Property Department, 170 Wood Avenue South, Iselin, NJ, 08830, US

(21) Appl. No.: 10/951,189

(22) Filed: Sep. 27, 2004

Related U.S. Application Data
(60) Provisional application No. 60/538,923, filed on Jan. 23, 2004.

(51) Int. Cl. G06F 9/44

(52) U.S. Cl. 717/104

(57) ABSTRACT

A method for developing a software product includes developing a machine-readable description of a requirements model defining a plurality of functionalities of the software product, developing an architectural framework for the product that includes definitions of a plurality of components that make up the product and facilities for loading and running a configuration of one or more components, and mapping functionalities of the requirements model into the components of the architectural framework. A centralized product management and engineering group develops the requirements model and architectural framework and coordinates an incremental development of the components of the product. One or more component development groups are assigned to develop one or more components of the software product so that components of the software product are developed concurrently. A schedule is set for delivery of each component to the centralized product management and engineering group.

### CROSS REFERENCE TO RELATED UNITED STATES APPLICATION

This application claims priority from “Architectures for Global Software Development”, U.S. Provisional Application No. 60/538,923 of Masticola, et al., filed Jan. 23, 2004, the contents of which are incorporated herein by reference.

### FIELD OF THE INVENTION

This invention is directed to processes for organizing and controlling large-scale software development at geographically distributed sites.

### BACKGROUND OF THE INVENTION

Software products are growing in complexity and the development organizations to implement new features are growing in staff size. Business managers are seeking new approaches to get new software products to market more quickly, while reducing overall development investments. One approach being promoted is the outsourcing of software development to lower cost development sites such as in India, China, and Eastern Europe. However, this approach is unlikely to be successful unless global development projects are planned and based on a software architecture design that meets business needs, including the requirements of structuring global development efforts.

Two goals of all commercial software development projects are: (1) to provide a product that creates value for a customer; and (2) to meet or exceed the profit goals associated with the development effort. To put it differently, products should be developed to maximize the return of the investment and to shorten the payback period. Putting software development into a profit context helps identify four economic success factors for a software product:
1. development cost;
2. product performance (product scope/functionality);
3. development time; and
4. unit cost.

Even though reducing development cost is important to maximize profits since any savings flows directly to the bottom line, for some development projects, development time, time to market, or product performance and the features/quality delivered can have an even greater impact on the cumulative profits. For example, consumer products such as mobile phones are typically required to hit a narrow market window, e.g., Christmas sales. If the development is delayed and the sales window is missed, the cumulative profits can be significantly reduced. In order to meet the profit target associated with a development project, it should be clear as to which economic success factor has the biggest impact on the cumulative profit.

Once the highest priority success factor has been identified for a development project, the product line can be designed and development efforts focused accordingly. If, for example, development time is crucial, the development process, software architecture and project organization should enable fast software development. Software architectures can be classified into three different types according to the four economic success factors previously identified:
1. Speed architectures, which mainly accelerate development, e.g., by providing a modular structure that allows parallel work on subsystems (economic success factor: development time).
2. Efficient architectures, which primarily enable cost-effective development, e.g., by providing a high degree of reuse (economic success factor: development cost), or, e.g., by implementing functionality in software rather than in hardware (economic success factor: low unit cost).
3. Performance architectures, which focus on product performance, e.g., by providing a high degree of extensibility or superior functionality (economic success factors: development cost and unit cost).
   Even though it is likely that a software product realizes more than one of the architecture types listed above, one should be clear on which one has the highest priority for a development effort.

Besides helping to reach the profit goals associated with a software development project, software architecture should enable a development group to develop a viable product that creates value for a customer. Additionally, software architecture should allow organizing globally distributed development groups along major subsystems to ensure that separate sub-groups work on distinct parts of the software system. Development may be accelerated by developing the major subsystems in parallel by the globally distributed development groups.

The business decision that a global development is necessary should be decided early in the design of the software architecture of the product line. In making such a business decision, influencing factors and the resulting design strategies need to be systematically analyzed. For example, the analysis may reveal that it would be difficult to implement a new product line at any single location, since no single development site has a full set of necessary development skills. Factors that influence the design of the product line include organizational, technological, and product factors. Analysis of the influencing factors can result in a set of design strategies that can be used to guide the product line architecture design. An example of how this analysis fits within the early phases of product line development is illustrated in FIG. 1.

Analysis of the factors influencing the software architecture design along with consideration of the economic success factors helps to identify the project goals. A project strategy to achieve a goal of best time to market might be to develop the product line globally such that many component development groups around the world could work in parallel, i.e., apply more skilled staff than may be available at a single location. A strategy to reduce development cost might be to use staff at lower cost development sites to develop parts of the product line using component-based or subsystem-based development approaches.

An example of an organizational influencing factor that could result in a decision to do global development is that the technical skills necessary to implement the application packages are in short supply. A strategy to address this factor could be to bootstrap and exploit expertise located at multiple development sites, to invest in training courses early in the development, and to make use of consultants. Also, design specification documentation could be developed describing the interfaces between major subsystems of the architecture, so that it is easier to parcel out a subsystem development to a remote software development site.

Another possible organizational factor is that business management wants to get the product to the market as quickly as possible. Since market conditions change rapidly, it may be critical to get some limited features of the product to potential users quickly so that their feedback could be solicited. A strategy to address this factor is to develop the product iteratively such that scheduled release dates are met even if some features are missing from the release. In this case project schedule takes priority over functionality. With such a strong emphasis on speed to market, development resources may need to be acquired wherever they could be found, which could result in development groups in multiple locations.

### SUMMARY OF THE INVENTION

Disclosed herein are software project planning and estimating methods for globally developing large software product lines based on modeling the requirements and designing the architecture to divide the functionality into small components that can be incrementally implemented. This is based on the observation that smaller software development projects are easier to manage and smaller development groups are more productive. Furthermore, many of today's agile software development processes are optimized to work best with development group sizes of ten staff or less. Thus, the global project planning methods of the invention use a central organization to manage a collection of small development groups each contributing to the development of a software component that fits within the software architecture. These methods of dividing a complex system into a number of smaller components has been observed within other engineering disciplines. For example, the Boeing 777 aircraft design was divided into 240 subsystems. Approximately 10,000 staff members were assigned to the development in total, but much smaller groups worked on the development of each subsystem.

The methods disclosed herein include the following, non-limiting series of steps for developing global software product lines.
Develop a machine-analyzable, visual requirements model that is centrally controlled.
Centrally design and enforce an architecture framework.
Decompose requirements and map them to software components within the architecture before commissioning the small distributed groups.
Use agile processes within the small component development groups.
Centralize incremental integration planning.
Implement a vertical slice model.
Synchronize communications among all development group leaders daily.
Follow the rules of thumb concerning component size, development schedule, and group size.
Implement a configuration management process and tools for multi-site development.
Centralize integration and testing. Use automated testing. Derive the tests from the requirements model.

In one aspect of the invention, there is provided a method for developing a software product. The method includes developing a machine-readable description of a requirements model defining a plurality of functionalities of the software product, developing an architectural framework for said software product that includes definitions of a plurality of components that make up the software product and facilities for loading and running a configuration of one or more of said components, and mapping functionalities of the requirements model into the components of the architectural framework. A centralized product management and engineering group is provided to develop the requirements model and architectural framework and to coordinate an incremental development of the components of the software product. One or more component development groups are provided, wherein the centralized product management and engineering group assigns each component development group to develop one or more components of the software product so that components of the software product are developed concurrently, and sets a schedule for delivery of each said component to the centralized product management and engineering group.

In another aspect of the invention, the method includes analyzing the requirements model to identify errors and inconsistencies, provide requirements extraction for process artifacts, provide constraints on component size, estimating the effort required to develop each component, and to generate test cases to validate the implemented components.

In another aspect of the invention, software tools are used to analyze the requirements model.

In another aspect of the invention, the requirements model is described in Unified Modeling Language (UML).

In another aspect of the invention, the architectural framework is specified using multiple views, including conceptual architecture, module interconnection architecture, execution architecture, and code architecture.

In another aspect of the invention, the architectural framework includes about 85 to 150 components.

In another aspect of the invention, the components of the architectural framework are limited to a maximum size of about 100,000 lines of code, so that each component can be developed within about ten man-years or less.

In another aspect of the invention, each product component can be developed independently and compiled and linked separately from the other product components.

In another aspect of the invention, the centralized product management and engineering group includes a requirements model development group to develop and control the requirements model.

In another aspect of the invention, the centralized product management and engineering group includes an architecture design group to define the architectural framework.

In another aspect of the invention, the method includes iteratively integrating the components being developed by the component development groups, and testing and validating the components of a previous development iteration while a next iteration of the product components are being developed.

In another aspect of the invention, integration, testing and validating of the components occurs about every 4 to 8 weeks.

In another aspect of the invention, the method includes providing testing and validation results of each component to the corresponding component development group before the next iteration date of the product components.

In another aspect of the invention, the centralized product management and engineering group includes an integration and testing group to integrate, system-test, and acceptance-test the product components.

In another aspect of the invention, members of the component development groups work with the centralized product management and engineering group to develop the requirements model and architectural framework.

In another aspect of the invention, the method includes providing a documentation package to each component group, wherein the documentation package includes a part of the requirements model relevant to the component to be developed by each group, an architecture framework description, an acceptance test that each component must satisfy, a development plan and integration schedule, a component interface specification, a vertical slice implementation, and a user interface style guide.

In another aspect of the invention, one or more of the component developments groups can be located at geographically separated sites.

In another aspect of the invention, the method includes providing, by each component development group, an estimate of the effort required to develop each component to the centralized product management and engineering group.

In another aspect of the invention, the method further includes considering organizational, technological, and product factors in the development of the architectural framework.

### BRIEF DESCRIPTION OF THE DRAWINGS

FIG. 1 depicts a schematic block diagram of how business analysis influences software architecture design.

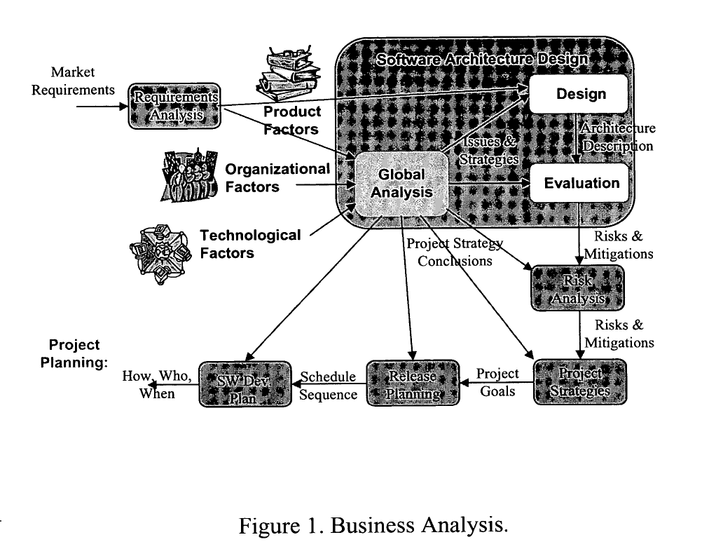

FIG. 2 depicts a flow chart of a preferred method of the invention.

FIG. 3 depicts an exemplary requirements model for a health care network management system

FIG. 4 depicts a schematic diagram of an exemplary architecture framework.

FIG. 5 depicts an exemplary organization chart.

### DETAILED DESCRIPTION OF THE PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

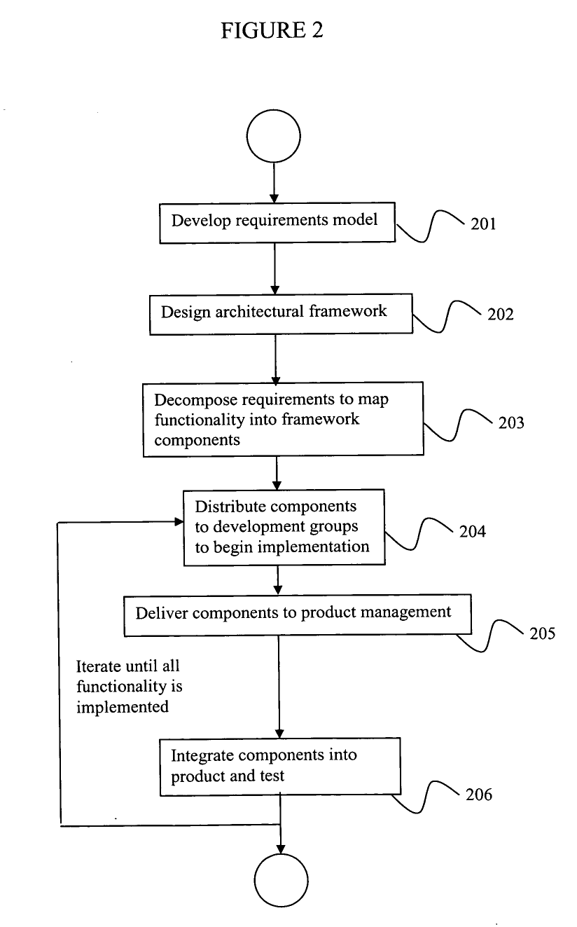

Referring now to FIG. 2, in one embodiment, global software development begins with developing, at step 201, a machine-readable description of the product line requirements modeled in the Unified Modeling Language (UML). An architecture framework is designed, at step 202, using multiple views to address the organizational, technological, and product factors identified as being unique to this product line to be sold in the global market. The requirements model is decomposed at step 203 so that functionality is mapped to software components that are defined within the architecture framework. A central product management and engineering organization (hereinafter referred to as product management for short) controls the requirements model and architecture, and it provides the incremental product planning such that existing products are migrated or developed to fit within the new architecture and user interface. Component development groups distributed among corporate development sites implement the components at step 204. Component development is organized such that components making up an individual application or product within the product line are developed within one product development site. Components will be delivered at step 205 from the component development groups to product management, who will, at step 206, integrate, validate, and test the components within a product solution. Component development can be done iteratively and synchronously using parallel workflows.

Product management provides rules of thumb, centralized processes, interface specifications and development constraints to the distributed component development groups. The requirements model and architectural framework are designed such that component sizes are defined to be relatively small with a maximum specified size in terms of lines of code, function points, development time, and development effort. The component development groups are constrained with respect to functionality, delivery schedule, effort, and schedule for developing their components. Product management synchronizes the concurrent development of the components and their functionality and is responsible for component integration. Product management can impose quality assurance constraints (e.g., design reviews, automated code inspections) consistent with the global software development process. Similarly, planned, frequent integration and testing of components delivered by the various development groups help to grow the software system systematically and to stabilize it on a regular basis.

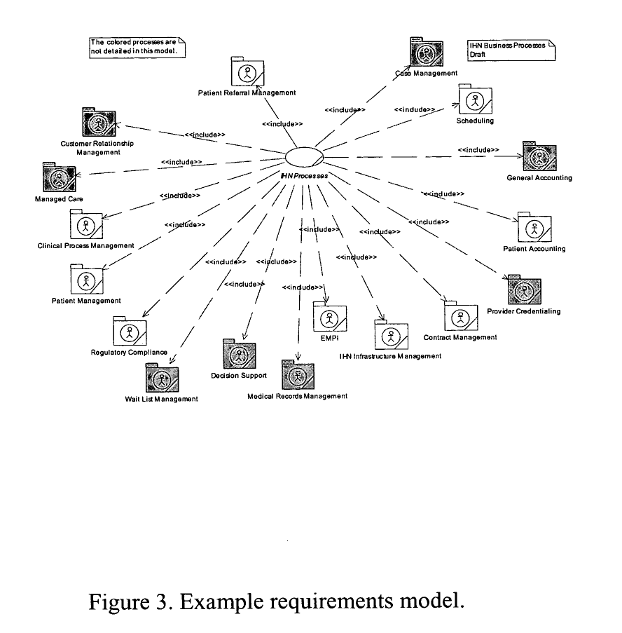

In one embodiment, product management includes a group responsible for developing and controlling the requirements model described in UML. FIG. 3 depicts a schematic diagram of a requirements model for software system that manages an integrated health care network. This requirements engineering group includes subject matter experts who know each of the existing products. The model is defined broadly in the beginning, with more levels of detail as functionality is incrementally added. Since the model is machine readable, software tools can be used to analyze the model to identify errors and inconsistencies, provide requirements extraction for process artifacts, provide constraints on maximum component size, estimate the effort requires to develop each component, and generate the automated test cases that will be used to validate the implemented products.

In one embodiment, product management also includes a group responsible for defining an architecture framework that includes all the components necessary to meet the product line's functionality. An architecture framework is a means of integrating a collection of loosely coupled components, including both the standards for building the components and the run-time facilities for loading and running a configuration of such components. The architectural framework can be designed and specified in terms of multiple views, including conceptual architecture, module interconnection architecture, execution architecture, and code architecture. Alternatively (or additionally), the architectural framework can be described using use case diagrams, component diagrams, sequence, state, and activity diagrams, and class diagrams in UML. The conceptual architecture describes the system in terms of its functional components and the interconnections between them. The module interconnection architecture describes the ideal implementation structure of the system in terms of functional decomposition and layers. The execution architecture describes the dynamic structure of the system in terms of its run-time components. The code architecture describes how the source code, binaries, and libraries of the system are organized in the development environment.

The architecture is organized so that independently developed subsystems are built as separate collections of components, interacting with other subsystems only through specified connections. A component can be compiled and linked separately from others and developed independently. Within the architecture framework, lower layered components can be mostly purchased, while higher layered components will be developed or existing application components can be restructured and wrapped to fit into the framework. The requirements model can be decomposed to allocate features to the designed application components. The architecture group can apply rules of thumb to limit the number of components in the design. In one embodiment, the number of components is limited to around 85-150. In addition, in one embodiment, the architecture is designed such that no individual component will be larger than about 100K lines of code of functionality and that each component can be developed within about 12 months by a 10-person development group.

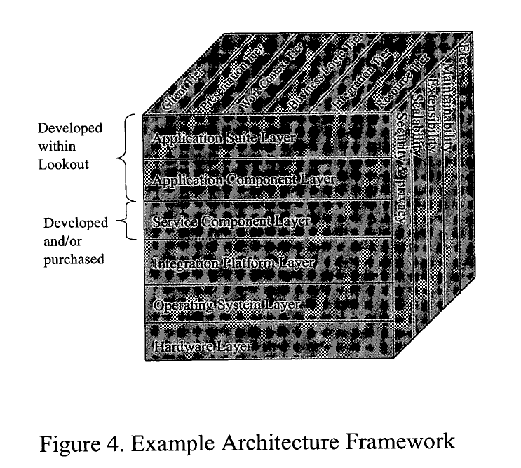

One conceptual model of an architectural framework is depicted in FIG. 4. This model framework is organized along three dimensions: tiers, layers, and systemic qualities. The tier is a logical or physical organization of components into an ordered chain of service providers and consumers. Components within a tier typically consume the services of those in an “adjacent” provider tier and provide services to one or more “adjacent” consumer tiers. Within a tier, services are grouped to like requirements, such as functionality, security, or load distribution. The layer is a hardware and software stack that hosts services within a given tier. Physical, network, and software platforms and standard APIs support the components that provide a service. Layers, like tiers, represent a well-ordered relationship across boundaries that are mediated by interfaces. Whereas tiers represent processing chains across components, layers represent container/component relationships in implementation and deployment of services. Systemic qualities are strategies, tools, and practices that provide availability, scalability, security, and manageability across the tiers and layers. In this framework, each application functionality tier is hosted by a layered hardware/software stack. Systemic qualities should be pervasive throughout the architecture, and each quality should be addressed for every layer and for every tier.

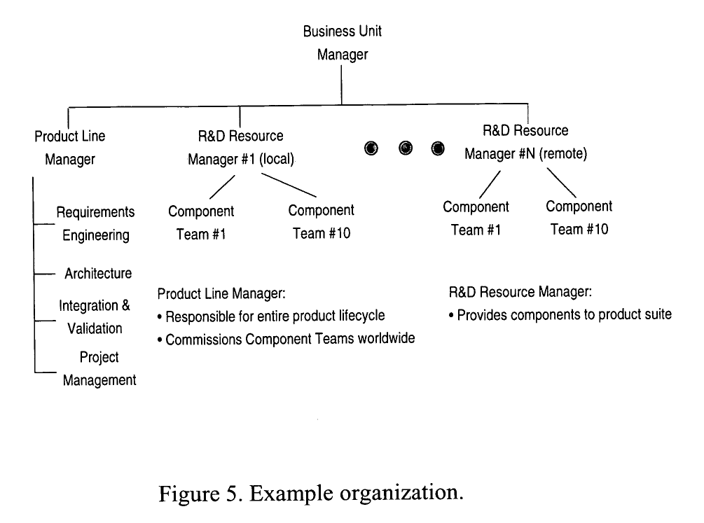

When all the components have been defined within the high-level framework design, product management can assign the distributed product development sites to implement each application component for the first products to be released in the product line. Integration can be done iteratively, such that the development of the components will be planned, controlled, and synchronized by product management. In one embodiment, integration is performed about every 4-8 weeks. An integration cycle of this frequency has been found through experience to be the most efficient. Product management includes a central integration and test group who will integrate, validate, and test the components within a product solution. FIG. 5 depicts a non-limiting example organization for implementing a product line.

The component development groups are responsible for technical solutions to implement the software components that make up the product line. The majority of staff within the component development group will be involved with the development phase of the product components. However, a small group of software architects and subject matter experts from the development groups can work with product management in the early phases of product line development to help develop the requirements model and architecture design. These experts can be temporarily located at the product management facility for this purpose during the early phases.

In one embodiment, the component development groups will be staffed with full-time staff members who are available from the beginning of the development iteration to its end. Some key staff members can be applied across all the component groups (e.g., architect, subject matter expert, project manager) at a specific development site.

To initiate the development of a new component, product management makes available to the component development groups a documentation package. This package can include the following items.
The requirements model: The model is described using UML and is published to a web site that each component group can access. In one embodiment, each component development group has access to only that portion of the requirements model that is relevant to their components. The central requirements engineering group annotates the model to indicate the functionality that the component groups will implement in each of their components and functionality that may be out of scope for the current iteration.
Software architecture description: The architecture is described using multiple views in an architecture description document and/or a design model.
Acceptance tests: The acceptance test(s) that the component must satisfy for the current iteration.
Incremental development plan and integration dates: A skeleton schedule is provided specifying the duration for the component development iterations and the fixed dates for components to be released to the central integration and test group.
Component interface specification: This specifies how the component to be developed will interface with the architecture framework.
Vertical slice implementation: This is a thin implementation of minimal executing functionality across all layers of the architecture to be used as an implementation example for the component development groups.
UI style guide: This specifies the user interface appearance design to be used for all products within the product line.
   Optionally, an updated documentation package can be provided to the development groups at the beginning of each development iteration period.

Upon delivery of the commissioning documentation package, the component development groups will be given predetermined period of time to provide an effort estimate to develop the identified components per the specified iterative development schedule. In one embodiment, the predetermined period of time is one week. Experience from past projects suggests a rule of thumb that about 4 hours are required for a bottom-up component effort estimate. If each member of a component development group does an estimate and the group size is limited to 10 staff members, then 40 hours could be applied to the bottom-up estimate per component during the one-week response time. In one embodiment, product management can accept without question component development estimates that are within a range of twice the estimate provided by analyzing the requirements model. In one embodiment, estimates that are significantly less than or more than twice the requirements estimate should be questioned. The estimates for potential high-risk components should also be reviewed and possibly adjusted.

Multiple iterative releases will be made to product management on specified fixed dates. The component groups should deliver on the specified release dates, or the entire product line development project will slip schedule. In some cases, a component development group may have to withhold functionality to meet the fixed release date. This missing functionality can be planned for development within the next iteration. Releases are delivered to the central integration and test group at the end of each iteration period.

The central integration and test group will begin system-testing and acceptance-testing after the first iteration period. System-testing involves looking for test cases that could cause a component to fail. Acceptance-tests are tests against the customer requirements, and frequently involve customer input. They will be testing the prior iteration while the component development groups are working on developing the next iteration. Test results can be provided to the component development groups prior to the next iteration date. Thus, the time required for doing an initial test sweep for a new iteration will be a factor for specifying the iteration period duration time.

In other embodiments of the invention, integration and testing can be performed by the component development groups. This is possible if there is an Internet accessible code base that all components groups can access, along with an Internet accessible build and test system.

Since the component development groups are asked to implement the product components given a time-boxed schedule with fixed iterative release dates, a requirements model, an architecture design, and an acceptance test, their development project will be well constrained with respect to functionality, schedule, and quality. The component development groups have some leeway considering the amount of effort that they quote for the development of each component. Since the central architecture design group has restricted the maximum size of an individual component, the maximum effort expected for an individual component will also be constrained, preferably to about 10 staff-years as a rule of thumb. These constraints should help minimize the risks associated with developing the product line.

One performance measure of a development group for this approach to global development is that each group participating in the product line development meet its fixed iteration release dates. Because of the synchronous highly parallel development approach that is optimized for time to market, even one group's slip of an iteration release will negatively impact the entire product line.

The impact of component size on software development can be observed in Table-1. This table summarizes the effort (in staff months), schedule, and peak staff required for developing different sized components (measured in thousands lines of code) for a product line as calculated from a calibrated cost estimation tool. It can be seen from the table, for example, that doubling the component size will more than double the effort predicted to develop the component.

TABLE 1
Component size impact on schedule & effort.

| KLOCs | Effort (SM) | Schedule (mos.) | Peak Staff |
|---|---|---|---|
| 10 | 3 | 5.5 | 0.9 |
| 20 | 9 | 7.1 | 2 |
| 30 | 24 | 8.6 | 3.8 |
| 40 | 46 | 10.1 | 6.3 |
| 50 | 56 | 10.6 | 7.5 |
| 60 | 85 | 11.8 | 10.3 |
| 70 | 117 | 12 | 14.6 |

If requirements are modeled and components are small and fit within an architecture framework, their development can be distributed around the world. Centralized project management control can support the architecture, high-level business model, system integration/validation, project planning, and user interface design for the distributed development of components.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

1. A method for making a software product comprising the steps of:
developing a machine-readable description of a requirements model defining a plurality of functionalities of the software product;
developing an architectural framework for said software product that includes definitions of a plurality of components that make up the software product and facilities for loading and running a configuration of one or more of said components;
mapping functionalities of the requirements model into the components of the architectural framework;
providing a centralized product management and engineering group to develop the requirements model and architectural framework and to coordinate an incremental development of the components of the software product;
providing one or more component development groups, wherein the centralized product management and engineering group assigns each component development group to develop one or more components of the software product; and
developing the components of the software product by each of said component development groups.

2. The method of claim 1, further comprising the step of analyzing said requirements model to identify errors and inconsistencies, provide requirements extraction for process artifacts, provide constraints on component size, estimating the effort required to develop each component, and to generate test cases to validate the implemented components.

3. The method of claim 2, wherein software tools are used to analyze said requirements model.

4. The method of claim 1, wherein said requirements model is described in unified modeling language.

5. The method of claim 1, wherein the architectural framework is specified using multiple views, including conceptual architecture, module interconnection architecture, execution architecture, and code architecture.

6. The method of claim 1, wherein the architectural framework is specified using use case diagrams, component diagrams, sequence, state, and activity diagrams, and class diagrams in UML.

7. The method of claim 1, wherein the architectural framework includes about 85 to 150 components.

8. The method of claim 1, wherein the components of the architectural framework are limited to a maximum size of about 100,000 lines of code, so that each component can be developed within about ten man-years or less.

9. The method of claim 1, wherein each product component can be developed independently and compiled and linked separately from the other product components.

10. The method of claim 1, wherein said centralized product management and engineering group includes a requirements model development group to develop and control the requirements model.

11. The method of claim 1, wherein said centralized product management and engineering group includes an architecture design group to define said architectural framework.

12. The method of claim 1, wherein said centralized product management and engineering group sets a schedule for delivery of each said component to the centralized product management and engineering group, further comprising the steps of iteratively integrating the components being developed by the component development groups, testing and validating the components of a previous development iteration while a next iteration of the product components are being developed, and repeating said steps of iteratively developing, integrating, testing and validating components until said software product is complete.

13. The method of claim 12, wherein integration, testing and validating of the components occurs about every 4 to 8 weeks.

14. The method of claim 12, further comprising the step of providing testing and validation results of each component to the corresponding component development group before the next iteration date of the product components.

15. The method of claim 12, wherein said centralized product management and engineering group includes an integration and testing group to integrate and test the product components.

16. The method of claim 12, further comprising providing an Internet accessible code base for the software product, and an Internet accessible build and test system, wherein each component development group tests and integrates their respective components.

17. The method of claim 1, wherein members of the component development groups work with the centralized product management and engineering group to develop the requirements model and architectural framework.

18. The method of claim 1, further comprising the step of providing a documentation package to each component group.

19. The method of claim 18, wherein the documentation package includes a part of the requirements model relevant to the component to be developed by each group, an architecture framework description, an acceptance test that each component must satisfy, a development plan and integration schedule, a component interface specification, a vertical slice implementation, and a user interface style guide.

20. The method of claim 1, wherein one or more of the component developments groups are located at geographically separated sites.

21. The method of claim 1, further comprising the step of providing, by each component development group, an estimate of the effort required to develop each component to the centralized product management and engineering group.

22. The method of claim 1, further comprising the step of considering organizational, technological, and product factors in the development of the architectural framework.

23. A method for organizing software product development comprising the steps of:
developing a machine-readable description of a requirements model defining a plurality of functionalities of the software product;
developing an architectural framework for said software product that includes definitions of a plurality of components that make up the software product and facilities for loading and running a configuration of one or more of said components;
mapping functionalities of the requirements model into the components of the architectural framework;
providing one or more component development groups, with each group developing one component of the software product, wherein components of the software product are developed concurrently, and wherein one or more of the component developments groups are located at geographically separated sites; and
iteratively developing and integrating the components of the software product until said software product complete, wherein the components of a previous development iteration are tested and validated while a next iteration of the product components are being developed.

24. The method of claim 23, further comprising the step of providing a documentation package to each component group, wherein the documentation package includes a part of the requirements model relevant to the component to be developed by each group, an architecture framework description, an acceptance test that each component must satisfy, a development plan and integration schedule, a component interface specification, a vertical slice implementation, and a user interface style guide.

25. The method of claim 23, further comprising the step of providing, by each component development group, an estimate of the effort required to develop each component.

26. The method of claim 23, further comprising providing a centralized product management and engineering group to develop the requirements model and architectural framework and to coordinate the iterative development of the components of the software product, wherein the centralized product management and engineering group assigns each component development group to develop one or more components of the software product and sets a schedule for delivery of each said component to the centralized product management and engineering group.

27. The method of claim 23, wherein said requirements model is described in unified modeling language, and further comprising the step of using software tools to analyze said requirements model to identify errors and inconsistencies, provide requirements extraction for process artifacts, provide constraints on component size, estimating the effort required to develop each component, and to generate test cases to validate the implemented components.

28. The method of claim 23, wherein the architectural framework is specified using multiple views, including conceptual architecture, module interconnection architecture, execution architecture, and code architecture.

29. The method of claim 23, wherein the architectural framework is specified using use case diagrams, component diagrams, sequence, state, and activity diagrams, and class diagrams in UML.

30. The method of claim 23, wherein the architectural framework includes about 85 to 150 components and are limited to a maximum size of about 100,000 lines of code, so that each component can be developed within about ten man-years or less, and wherein each component can be developed independently and compiled and linked separately from the other components.

31. The method of claim 26, wherein said centralized product management and engineering group includes a requirements model development group to develop and control the requirements model.

32. The method of claim 26, wherein said centralized product management and engineering group includes an architecture design group to define said architectural framework.

33. The method of claim 26, wherein said centralized product management and engineering group includes an integration and testing group to integrate and test the product components.

34. The method of claim 23, wherein integration, testing and validating of the components occurs about every 4 to 8 weeks.

35. The method of claim 26, wherein members of the component development groups work with the centralized product management and engineering group to develop the requirements model and architectural framework.

36. The method of claim 23, further comprising providing an Internet accessible code base for the software product, and an Internet accessible build and test system, wherein each component development group tests and integrates their respective components.

37. The method of claim 23, further comprising the step of considering organizational, technological, and product factors in the development of the architectural framework.

38. A method for organizing software product development comprising the steps of:
developing a machine-readable description of a requirements model defining a plurality of functionalities of the software product;
developing an architectural framework for said software product that includes definitions of a plurality of components that make up the software product and facilities for loading and running a configuration of one or more of said components;
mapping functionalities of the requirements model into the components of the architectural framework;
providing a centralized product management and engineering group to develop the requirements model and architectural framework;
providing one or more component development groups, with each group developing one component of the software product wherein components of the software product are developed concurrently, wherein one or more of the component developments groups are located at geographically separated sites;
providing a documentation package to each component group; and
iteratively developing and integrating the components of the software product until said software product is completed, wherein the components of a previous development iteration are tested and validated while a next iteration of the product components are being developed, wherein the centralized product management and engineering group coordinates the iterative development of the components of the software product, assigns each component development group to develop one or more components of the software product and sets a schedule for delivery of each said component to the centralized product management and engineering group

39. The method of claim 38, wherein the documentation package includes a part of the requirements model relevant to the component to be developed by each group, an architecture framework description, an acceptance test that each component must satisfy, a development plan and integration schedule, a component interface specification, a vertical slice implementation, and a user interface style guide.

40. The method of claim 38, further comprising the step of providing, by each component development group, an estimate of the effort required to develop each component to the centralized product management and engineering group.

41. The method of claim 38, wherein said requirements model is described in unified modeling language, and further comprising the step of using software tools to analyze said requirements model to identify errors and inconsistencies, provide requirements extraction for process artifacts, provide constraints on component size, estimating the effort required to develop each component, and to generate test cases to validate the implemented components.

42. The method of claim 38, wherein the architectural framework is specified using multiple views, including conceptual architecture, module interconnection architecture, execution architecture, and code architecture, and includes about 85 to 150 components and are limited to a maximum size of about 100,000 lines of code, so that each component can be developed within about ten man-years or less, and wherein each component can be developed independently and compiled and linked separately from the other components.

43. The method of claim 38, wherein the architectural framework is specified using use case diagrams, component diagrams, sequence, state, and activity diagrams, and class diagrams in UML, and includes about 85 to 150 components and are limited to a maximum size of about 100,000 lines of code, so that each component can be developed within about ten man-years or less, and wherein each component can be developed independently and compiled and linked separately from the other components.

44. The method of claim 38, wherein said centralized product management and engineering group includes a requirements model development group to develop and control the requirements model, an architecture design group to define said architectural framework, and an integration and testing group to integrate and test the product components.

45. The method of claim 38, wherein integration, testing and validating of the components occurs about every 4 to 8 weeks.

46. The method of claim 38, wherein members of the component development groups work with the centralized product management and engineering group to develop the requirements model and architectural framework.

47. The method of claim 38, further comprising the step of considering organizational, technological, and product factors in the development of the architectural framework.

48. The method of claim 38, further comprising providing an Internet accessible code base for the software product, and an Internet accessible build and test system, wherein each component development group tests and integrates their respective components.
